(19) United States
(12) Patent Application Publication
(10) Pub. No.: US 2016/0175932 A1
(43) Pub. Date: Jun. 23, 2016

(54) ADDITIVE MANUFACTURING METHOD AND APPARATUS

(71) Applicant: RENISHAW PLC, Wotton-under-Edge, Gloucestershire (GB)

(72) Inventors: Marc DIMTER, Kornwestheim (DE); Ralph MAYER, Kornwestheim (DE)

(73) Assignee: RENISHAW PLC, Wotton-under-Edge, Gloucestershire (GB)

(21) Appl. No.: 14/910,532

(22) PCT Filed: Aug. 4, 2014
(86) PCT No.: PCT/GB2014/052386

§ 371 Date: Feb. 5, 2016

(30) Foreign Application Priority Data
Aug. 5, 2013 (GB) 1313926.6

(51) Int. Cl. B22F 3/105; B23K 26/342; B23K 37/04; B22F 3/24

(52) U.S. Cl. CPC B22F 3/1055; B22F 3/24; B23K 26/342; B23K 37/04; B22F 2003/1058; B22F 2003/247; B33Y 10/00

(57) ABSTRACT

An additive manufacturing method including building an object layer-by-layer by, repeatedly, providing a layer of material on build platform and scanning a beam across the layer to consolidate material. A plurality of supports may be provided for supporting object during build. Each support may include main body attached to the object by 2-dimensional pattern of frangible structures. The method may further include applying input force to main body to displace main body to break the frangible structures. Also relates to a support structure that may be used in this method. The support structure may include plurality of supports for supporting the object, each support including main body attached to object by a 2-dimensional pattern of frangible structures. The supports may be arranged such that main bodies define a gap therebetween into which at least one of main bodies can be displaced by an input force to break the frangible structures.

### SUMMARY OF INVENTION

This invention concerns an additive manufacturing method and apparatus and, in particular, but not exclusively, a method and apparatus of building a support for an object built using additive manufacturing such that the object can be easily released from the support at the end of the build. The invention has particular application to the building of an object and associated support structure from metal powder.

### BACKGROUND

In additive manufacturing processes, such as selective laser melting (SLM) or selective laser sintering (SLS), objects are built layer-by-layer by consolidation of a material, such as powder material, using a focussed high energy beam, such as a laser beam or electron beam. In SLM or SLS, successive layers of powder are deposited on to a build platform and a focussed laser beam scanned across portions of each layer corresponding to a cross-section of the object being constructed such that the powder at the points the laser scans are consolidated. Examples of an additive manufacturing process are described in U.S. Pat. No. 6,042,774 and WO2010/007394.

In order to anchor the object in place and to prevent or at least reduce deformations of the object, such as curling, during the build, it is known to build supports of the same material extending from the build platform to the under-surfaces of the object. Typical support structures comprise a series of thin struts that extend from the build platform to the object. At the end of the build, the supports are removed from the object to provide the finished article. However, it has been found that it is difficult to remove these supports in a repeatable fashion such that each object (for example in a series of nominally identical objects) looks the same.

As an example, FIGS. 1a to 1c shows supports 1 arranged in a grid pattern that can be created using Magics, a software package sold by Materialise GmbH. In this example, the object 2 is a cog having a central recess 3. The supports 1 extend into the recess 3 to support the downwardly facing surfaces 4 of the object 2 within the recess 3. It is very difficult to remove the supports 1a located in the recess 3. Furthermore, the high supports, such as the supports la that extend into the recess 3, may bend when contacted by a wiper during spreading of the powder layer.

It is known to provide weakened break points at the top of the support, for example as disclosed in EP0655317, EP1120228 and EP1358855, that facilitates the release of the support from the object. However, weakening of the regions of the supports can result in insufficient support for the object. For example, thermally generated forces urging the object to curl during the build can cause the object to break away from the supports at these weakened break points causing distortion and possible failure of the build.

WO2012/131481 discloses supports with pre-defined breaking points and volume elements that act as a heat sink.

U.S. Pat. No. 5,595,703 discloses supports for use in sterolithography whose diameter increases towards the top such that a maximum support is obtained at the top for the object, whilst a minimum amount of material is used at the bottom.

### SUMMARY OF INVENTION

According to a first aspect of the invention there is provided an additive manufacturing method comprising building an object layer-by-layer by, repeatedly, providing a layer of material on a build platform and scanning a beam across the layer to consolidate the material, wherein a plurality of supports are provided for supporting the object during the build, each support comprising a main body attached to the object by a 2-dimensional pattern of frangible structures, the method further comprising applying an input force to the main body to cause displacement of the main body to break the frangible structures.

The frangible structures ensure that the object can be separated from the supports at repeatable positions whilst the 2-dimensional pattern of supports may ensure that sufficient support is provided to prevent detachment of the frangible structures from the object during the build. In particular, the pattern of frangible structures provides strength in both dimensions. The provision of the support structure as a plurality of separate main bodies allows the supports to be more easily removed from the object. The main bodies may provide sufficient rigidity to prevent bending of high supports through contact with a wiper blade. Furthermore, the main bodies may act as a better heat sink than the grid-like structures described with reference to FIGS. 1a to 1c.

The input force may be applied at a location on the main body such that a lever action of the main body provides a resultant force on each of the frangible structures greater than the input force.

The invention facilitates removal of the supports from the object through the lever action whilst ensuring that the supports are separated at repeatable positions defined by the frangible structures.

The frangible structures have a different structure to the main body such that, under the input force, the frangible structures break more readily than the main body. The main body may have sufficient structural integrity such that an input force can be applied to cause the main body to pivot to break the frangible structures without significant deformation of the main body, e.g. the structure of the main body when released from the object is substantially the same as during the build. The force required to significantly deform the main body may be much greater than the input force required to break the frangible structures.

The main body may be pillar or pier for supporting the object, the pillar or pier connected to the object by the frangible structures. The main body may be a solid block/monolith, a shell with solid walls or lattice structure. The main body may have a substantially homogenous structure throughout the volume that it occupies.

For example, in the case of the main body comprising a lattice structure, a framework of the lattice structure may be formed from a 3-dimensional unit cell repeated throughout a volume of the main body.

The 2-dimensional pattern of frangible structures may be a regular pattern, such as a grid of frangible structures, or an irregular pattern of frangible structures. The pattern of frangible structures is a 2-dimensional pattern and therefore, is not a single line of weakened break points, as disclosed in EP0655317 and U.S. Pat. No. 7,084,370. A single line of weakened break points may not provide sufficient lateral support, allowing the support to collapse in a direction perpendicular to the line of weakened break points under lateral forces that occur during the build. A 2-dimensional pattern of frangible structures may ameliorate this problem by increasing the resistance to lateral forces that occur during the build.

The 2-dimensional pattern of frangible structures may comprise a plurality of repeated units. The frangible structures may comprise a plurality of separate frangible units arranged in a 2-dimensional pattern, such as separate columns each having a sufficiently small cross-section to break on application of the input force or separate cones or other shapes that narrow to such a sufficiently small cross-section. Alternatively, the frangible structures may comprise frangible units that are joined to form one or more larger structures. For example, the frangible structures may comprise a grid of thin walled sections that break on application of the input force.

The frangible structures may be arranged to provide support at two or more spaced apart positions in a first direction parallel to a surface of the object and to provide support at two or more spaced apart positions in a second direction parallel to the surface of the object and perpendicular to the first direction. The distances between the spaced apart positions may be less than 0.8 mm and preferably 0.6 mm. The distances between the spaced apart positions may be greater than 0.2 mm and preferably 0.4 mm.

Preferably, the gap between the main bodies at a location nearest the object is less than a maximum distance between elements of the frangible structures. For example, the gap may be less than 0.5 mm and preferably less than 0.4 mm.

The input force may be applied to a distal end of the main body that is remote from the frangible structures. The input force may be applied with a tool, such as a hammer or the like.

The method may comprise building the supports using the additive manufacturing process.

According to a second aspect of the invention there is provided a support structure for supporting an object during additive manufacturing, wherein an object is built layer-by-layer by, repeatedly, providing a layer of material on a build platform and scanning a beam across the layer to consolidate the material, the support structure comprising a plurality of supports for supporting the object, each support comprising a main body attached to the object by a 2-dimensional pattern of frangible structures.

The supports may be arranged such that the main bodies define a gap therebetween into which at least one of the main bodies can be pivoted by an input force to break the frangible structures. The gap may be dimensioned such that the main body has sufficient throw to break the frangible structures.

A shape of the main body may enable the input force to be applied to a location on the main body to result in a resultant force on each of the frangible structures greater than the input force.

The main body may have a distal (bottom) end portion to which the input force can be applied to pivot the main body about a pivot point that is a greater distance from the pivot point than the frangible structure that is furthest from the pivot point in a direction perpendicular to an axis of rotation about the pivot point. In this way, the relative moments about the pivot point are such that the resultant force applied to the frangible structures is greater than the input force.

At least one of the main bodies may taper from the object towards the build platform to provide sufficient space between the main body and an adjacent main body of one of the other supports to enable pivotal movement of the or the adjacent main body into the space to break the frangible structures.

A top of each main body may follow a contour of the object to provide a set gap between the main body and the object that is spanned by the frangible structures. The height of the frangible structures (and therefore the size of the set gap) may be less than 1 mm, and preferably less than 0.5 mm and most preferably less than 0.3 mm.

A main body of one of the supports that is adjacent a main body of another support may comprise an undercut into which a top of the main body of the other support projects.

One or more of the main bodies may be hollow (full of un-melted and/or un-sintered powder) and/or comprise an aperture therein. This may reduce the volume of the main body to save material during the build. The solidified material that forms one or more of the main bodies may not be fully dense. Making supports that are not fully dense using the additive manufacturing process may be quicker than making fully dense supports using the process.

Each support may comprise further frangible structures that attach the main body to the build platform.

According to a third aspect of the invention there is provided geometric data for use in controlling an additive manufacturing process, the geometric data defining an object to be built using the additive manufacturing process and support structures according to the second aspect of the invention for supporting the object during the additive manufacturing process.

The geometric data may be provided on a suitable data carrier.

According to a fourth aspect of the invention there is provided a method of generating geometric data for use in controlling an additive manufacturing process, the method comprising, based on an object to be built using the additive manufacturing process, designing support structures according to the second aspect of the invention and generating geometric data defining the support structures.

According to a fifth aspect of the invention there is provided a data carrier having instructions stored thereon, the instructions, when executed by a processor, causing the processor to receive object data defining an object to be built using an additive manufacturing process and to automatically generate geometric data defining support structures according to the second aspect of the invention based on the object data.

The data carrier may be a suitable medium for providing a machine with instructions/data such as non-transient data carrier, for example a floppy disk, a CD ROM, a DVD ROM/RAM (including -R/-RW and +R/+RW), an HD DVD, a BIu Ray™ disc, memory (such as a Memory Stick™, an SD card, a compact flash card, or the like), a disc drive (such as a hard disk drive), a tape, any magneto/optical storage, or a transient data carrier, such as a signal on a wire or fibre optic or a wireless signal, for example a signals sent over a wired or wireless network (such as an Internet download, an FTP transfer, or the like).

### DESCRIPTION OF THE DRAWINGS

FIG. 1a is a perspective view of an object to be manufactured using an additive manufacturing process;

FIG. 1b is a perspective view of the object shown in Figure la together with a grid of support structures generated using Magics;

FIG. 1c is a view of the object and grid of support structures with a section of the object cut-away to illustrate the grid of support structures that extends into a recess in the object;

FIG. 2a is a perspective view of the object shown in Figure la together with a support structure according to an embodiment of the invention;

FIG. 2b is a perspective view of the object and support structure illustrated in FIG. 2a with a section cut-away;

FIG. 2c is a plan view of a support structure illustrating a pattern of frangible structures in accordance with one embodiment of the invention;

FIG. 3a is a side-view of an object and support structure according to another embodiment of the invention;

FIG. 3b is an enlarged view of the object and support structure shown in FIG. 3a;

FIG. 3c is an enlarged view of the portion of FIG. 3b within circle A;

FIG. 3d is a perspective view of the support structure shown in FIGS. 3a to 3c;

FIG. 4 is a side-view of an object and support structure according to another embodiment of the invention;

FIG. 5 is a perspective view of an object and support structure according to another embodiment of the invention; and

FIG. 6 is a schematic view of a support according to another embodiment of the invention.

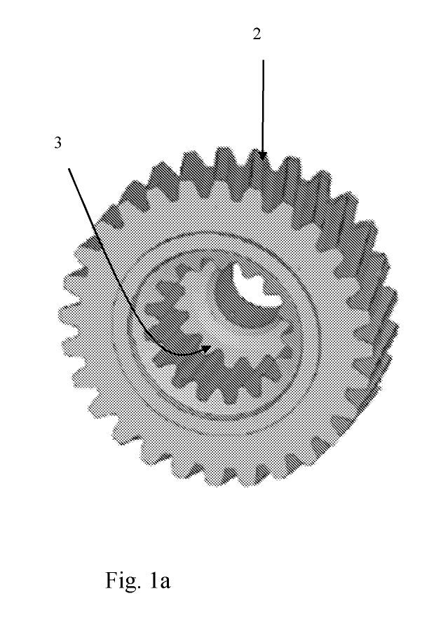

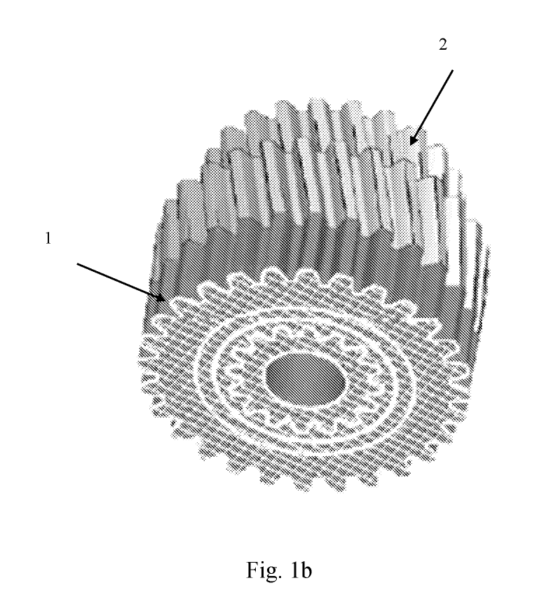

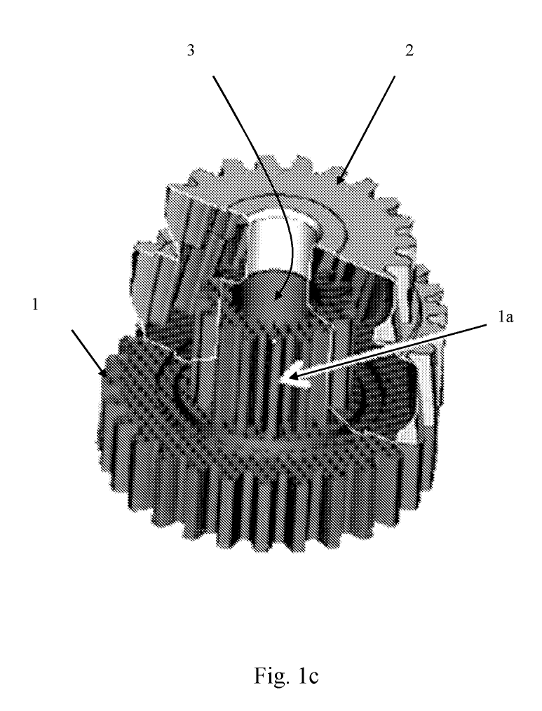

### DESCRIPTION OF EMBODIMENTS

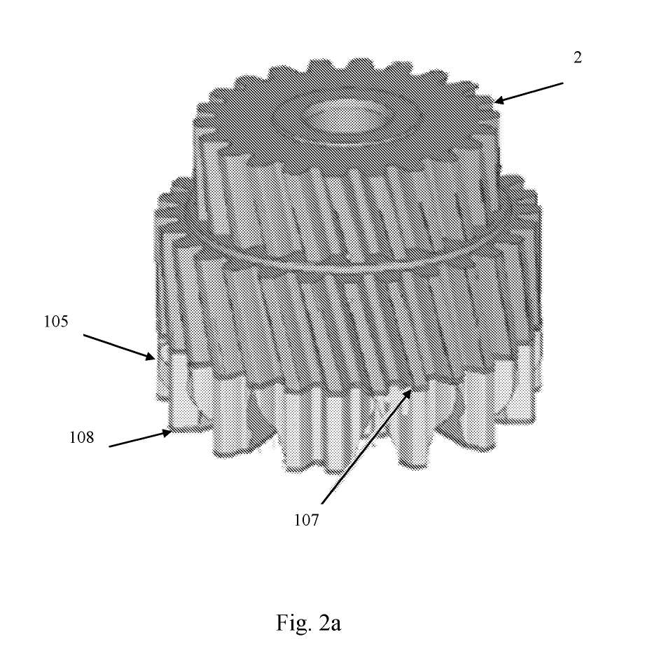

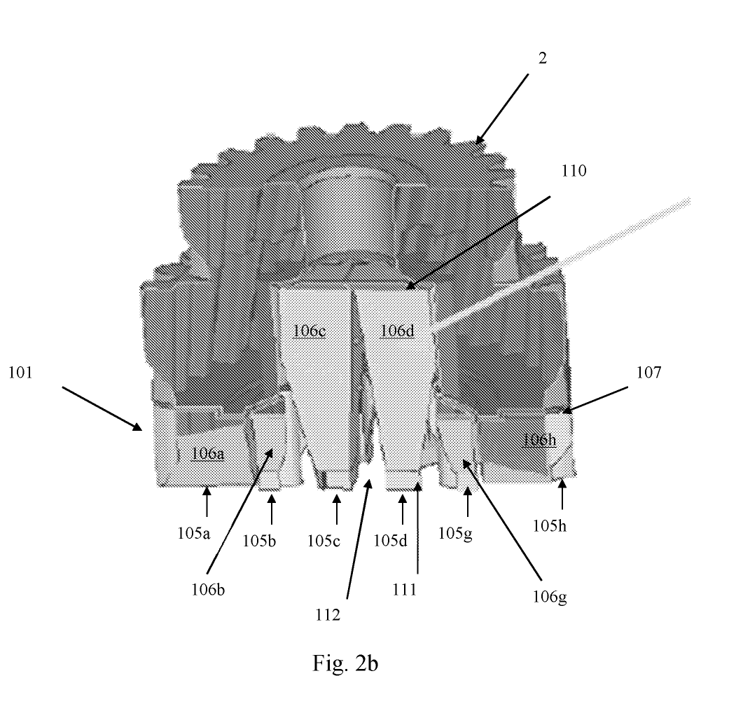

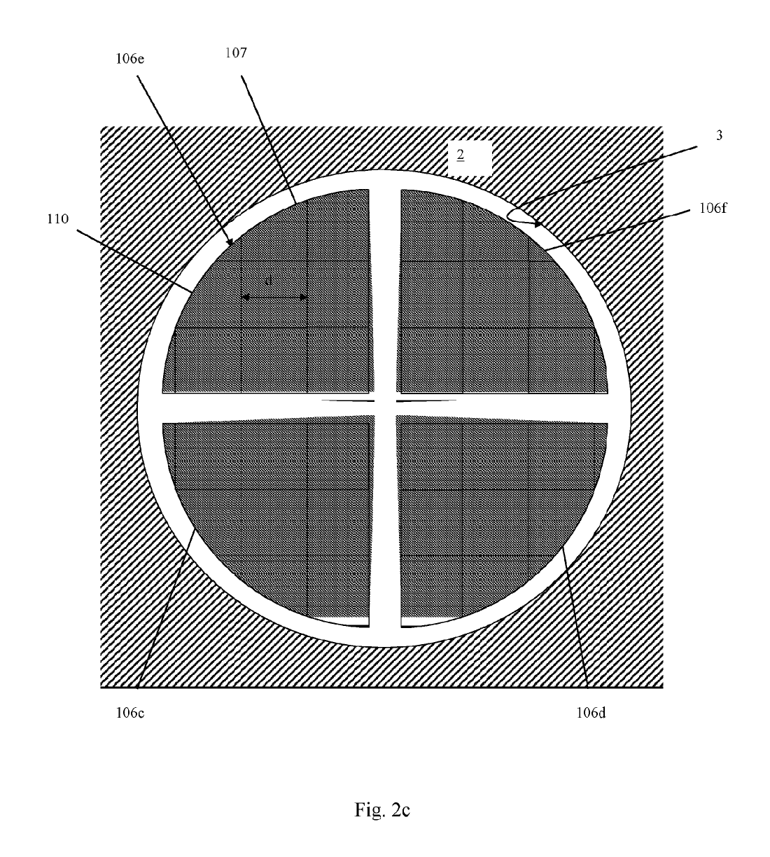

Referring to FIGS. 2a to 2c, a support structure 101 for supporting an object 2 during additive manufacturing, such as SLM or SLS, comprises a plurality of separate supports 105a to 105h for supporting the object. Each support comprises a main body 106a to 106h attached to the object by a 2-dimensional pattern of frangible structures 107 that can be broken by application of a force to the main body 106a to 106h. The main body 106a to 106h is a block of material solidified using the SLM or SLS process. In FIG. 2c a regular grid pattern of frangible elements 107 is shown for the supports 105c, 105d, 105a and 105f. Each support further comprises further frangible structures 108 that attach the main body 106a to 106h to the build platform (not shown).

The main bodies 106a to 106h are arranged to define gaps 112 therebetween into which the main bodies 106a to 106h can be displaced by an input force. Each gap 112 is dimensioned such that each main body 106a to 106h has sufficient throw to break the frangible structures 107a to 107f. In particular, at least some of the main bodies 106a to 106h taper away from an upper, proximal end 110 towards a lower, distal end 111 such that the gap 112 is provided between main bodies 106 of adjacent supports 105. The taper allows the main body 106a to 106h to pivot about a point close to the object when the main body 106 is displaced into the gap 112. The length and rigidity of the main bodies, 106b to 106e is such that an input force can be applied to the distal end 111 to displace the main body 106 into the gap 112 such that a resultant force on each of the frangible structures 107 is greater than the input force. In this embodiment, the throw may be between 5 to 30 degrees.

A top of each main body 106 follows a contour of the object 2 to provide a set gap between the main body and the object that is spanned by the frangible structures 107. In this embodiment, the frangible structures 107 comprise a grid that can be broken on application of a force to the main body 106a to 106h. The grid has a height of 0.3 mm. The distance, d, between parallel walls of the grid structure is between 0.4 and 0.8 mm. It has been found that, for metal objects, such a steel objects, a width of 0.4 mm ensures that the walls are built as separate elements (typically a diameter of a melt pool generated in an SLM process will be approximately 0.2 mm so a distance of 0.4 mm ensures that the melt pools generated to build adjacent walls of the grid remain separate). For certain shapes, droop of the object is observed for separations of the walls beyond 0.8 mm. Small amounts of droop may be acceptable so distances beyond 0.8 mm may be used in certain applications. Of course, the support required will vary for object shape and orientation and particular objects or particular orientations of objects may be built to an acceptable level with greater distances between the walls of the grid. The 0.4 to 0.8 mm grid size provides a grid size that will provide acceptable results in the majority of circumstances.

A top of the main bodies 106 has a maximum width, W, of 8 to 10 mm. Widths beyond this may make the input force required to break the frangible structures 107 greater than that which can be easily applied using manually operated tools.

The support structures 105 are built during the additive manufacturing process typically using the same material, such as steel, as that used to build the object 2. At the end the build process, a force is applied individually to the main body 106a to 106h of each support 105a to 105h to displace the main body 106a to 106h to break the frangible structures 107. In particular, the tapered shape of certain ones of the main bodies, allows each main body 106a to 106h to be displaced to pivot around a point at the main bodies proximal end 110 to pull the proximal end 110 of the main body away from the object and break the frangible structures 107. Application of the force will also break the frangible elements 108 attaching the supports to the build platform. The input force may be applied close to the distal end 111 of the main body 106a to 106h. For example, the input force may be applied using a pointed tool, such as a chisel 220, applied to the distal end of the main body 106 to which a force can be applied with, for example, a mallet or hammer 221.

The length of the main body 106b to 106g of supports 105b to 105g is longer than the proximal end 110 of the main body 106b to 106g is wide, for example, 20 mm high to 10 mm wide. Accordingly, an input force applied to a distal end 111 of the main body 106b to 106g will be a greater distance away from a pivot point/line than any one of the frangible structures 107 at the proximal end 110. In this way, the relative moments about the pivot point are such that the resultant force applied to the frangible structures is greater than the input force.

In order that the input force is transmitted to the frangible structures 107 by the displacement of the main body 106, the main body 106 must be suitably rigid. In this embodiment, the main body is a solid block formed by complete melting of the powder material in the SLM process. However, it will be understood that the main body may not be a fully dense object as long as this provides sufficient rigidity. For example, the main body could be formed by sintering rather than melting of the powder material by reducing the surface power density of the laser beam when forming the support structures.

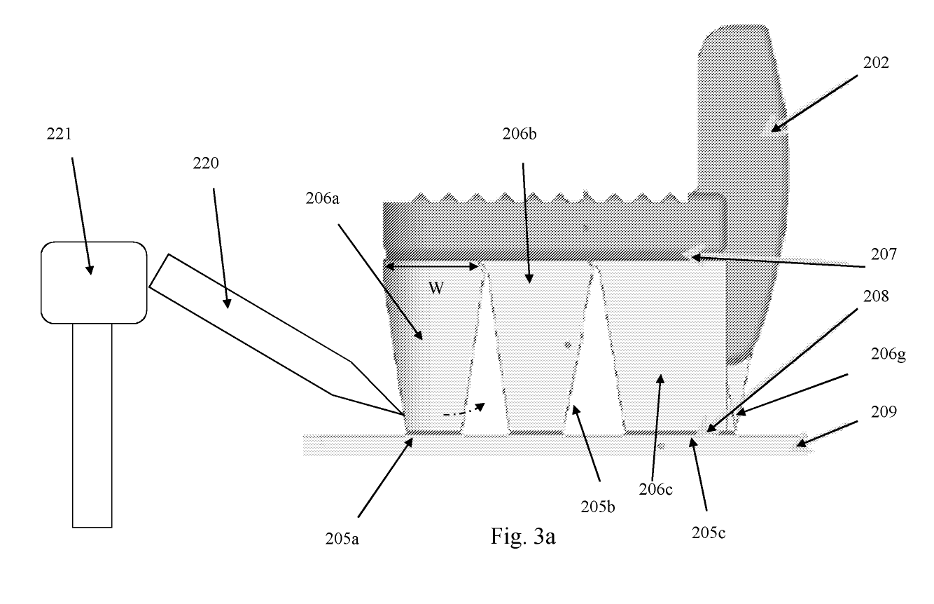

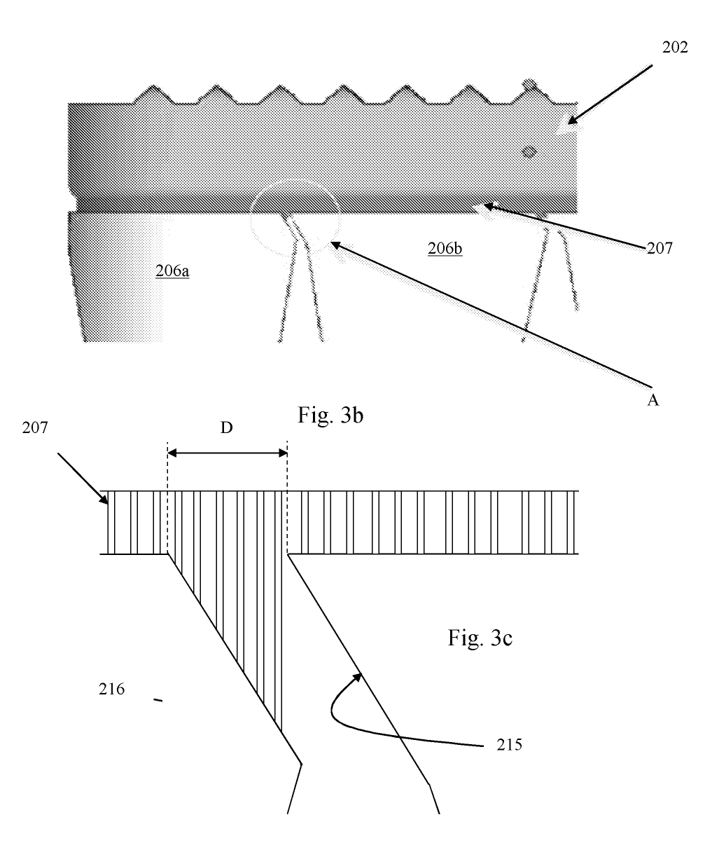

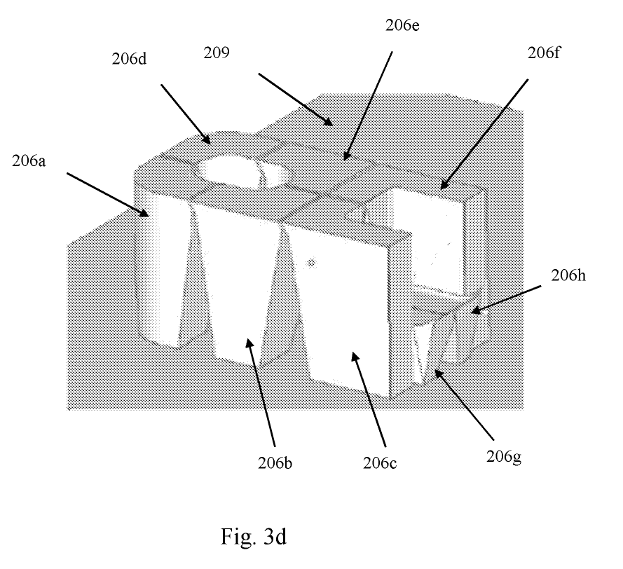

Referring to FIGS. 3a to 3d, a further embodiment of the invention is shown. In this embodiment an object 202 is supported during an SLM build using supports 205a to 205h. Like the previous embodiment, frangible structures 207 and 208 are provided at the ends of the main bodies 206a to 206h proximal to the object 202, to attach the main bodies 206a to 206h to the object 202, and at the ends of the main bodies 206a to 206h distal from the object 202, to attach the main bodies 206a to 206h to the build platform 209.

However, in this embodiment, the main body 206 of one of the supports 205 that is adjacent a main body 206 of another support 205 comprises an undercut 215 into which a projection 216 at the top of the main body 206 of the other support 205 projects. Such an arrangement may be advantageous when automatically generating the frangible structures 207 in software, which generates the frangible structures 207 by projecting the frangible structures down from a downwardly facing surface of the object 202 to an upwardly facing surface of a structure (main body or build platform 209) that is below. If there is a gap, D, between adjacent main bodies at the proximal end 210 with no part of one of the main bodies extending beneath the gap, the frangible structures will be projected downwards from a surface of an object to the build platform. The undercut 215 and projection 216 ensure that there is no vertical line along which a frangible structure 207 can be projected that does not intercept with a main body 206 of a support 205. Without the undercut, the distance D is preferably of the same size as the distance between walls of the grid. However, with the undercut the distance D can be larger, as shown in FIG. 3c

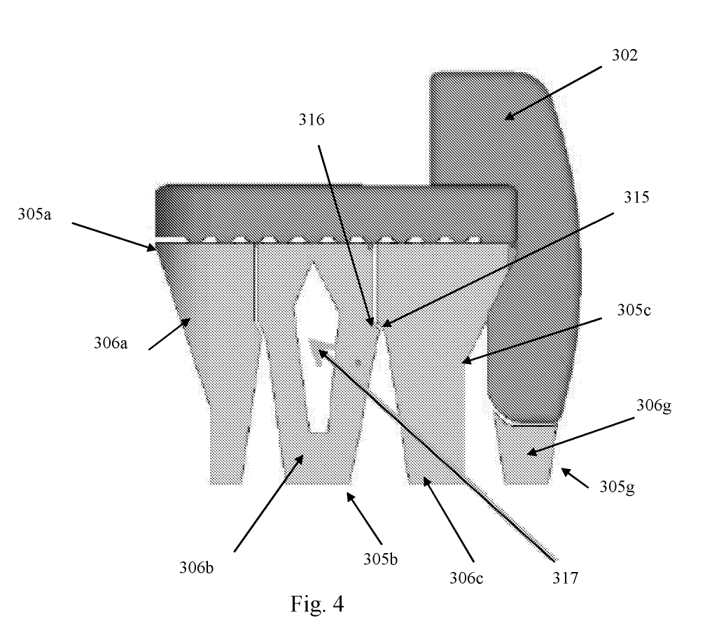

FIG. 4 illustrates how the main body 306 may comprise an aperture 317 to reduce the amount of material that is used to form the main body 306. The aperture 317 should be designed such that the main body 306 still has sufficient rigidity for transmission of the forces during removal of the main body 306 from the object 302 by breaking the frangible structures 307. In this embodiment, the undercuts 315 and corresponding projections 316 are provided further down the main bodies 306. This may result in pivotal motion of the main bodies 306 when detaching the frangible structures 307 around points in the vicinity of the undercuts 315 and projections 316 rather than points located at the top of the main body 306

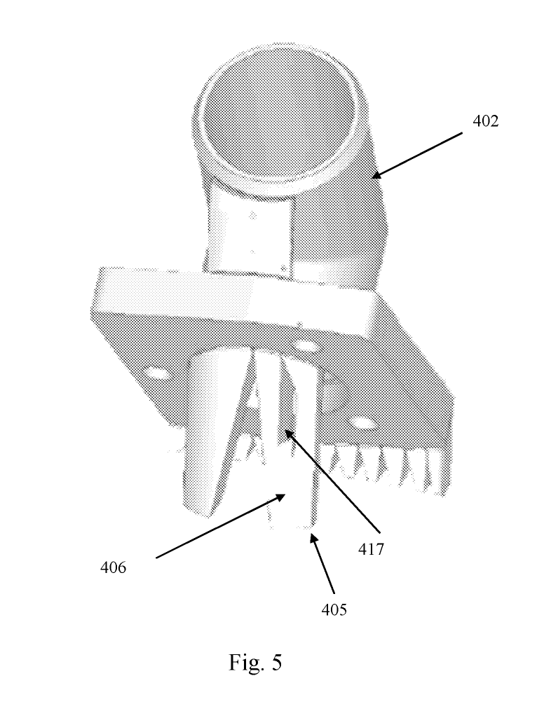

FIG. 5 illustrates an alternative embodiment, wherein supports 405 only support part of the downwardly facing surfaces of an object 402.

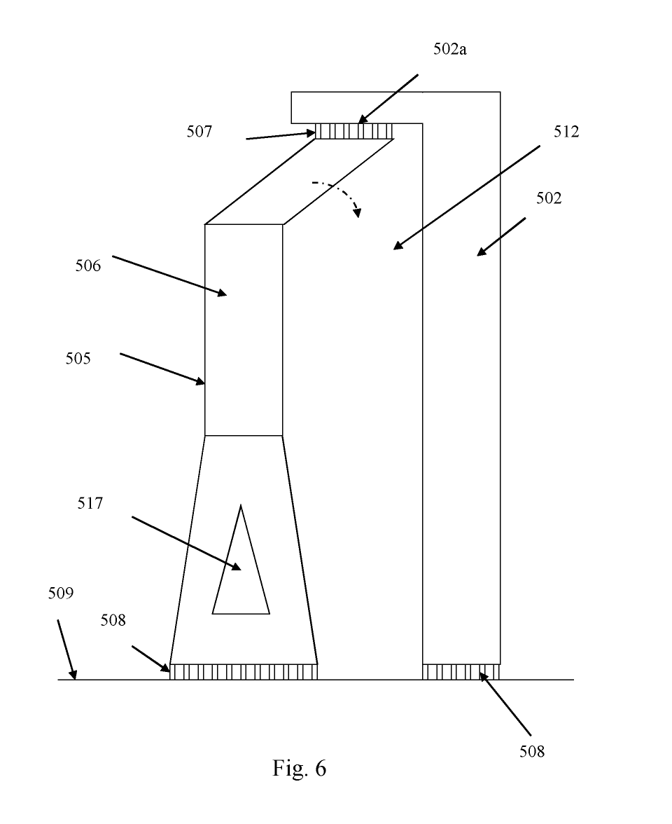

FIG. 6 illustrates a support 505 for supporting an overhang 502a of an object 502, wherein access to the space below the overhang 502a is restricted. In this embodiment, if a support is provided directly below the overhang 502a, it would not be possible to displace the support to break frangible structures because the object 502 prevents displacement of the support in one direction and the restricted access prevents placement of a tool on the support to displace the support in the other direction. Accordingly, a support 505 is provided wherein the main body 506 is shaped to extend away from the object 502 so as to provide a gap 512 therebetween. The main body 506 tapers from an end distal from the object 502 to an end proximal the object 502. Application of a force to the proximal end causes the main body 506 to pivot into gap 512 about a point at the distal end, breaking the frangible structures 507 and 508.

It will be understood that in FIGS. 3a to 3d, 4, 5 and 6, like reference numbers but in the series 200, 300, 400 and 500, respectively, are used for elements that are similar or the same as elements described with reference to other Figures.

The supports described above may be designed automatically in software on a computer separate from the SLM machine. The supports may be designed based upon the object that is to be built. The computer generates geometric data defining an object and support structures to be built using the SLM process and this geometric data is transferred to the SLM machine via a suitable data carrier for carrying out the build.

It will be understood that modifications and alterations can be made to the embodiments described herein without departing from the scope of the invention as defined in the claims.

For example, rather than a solid body, the main bodies may comprise a shell or lattice structure. The main bodies may be designed as hollowed tubes/shells with an overall closed surface, thus carrying loose powder inside.

1. An additive manufacturing method comprising building an object layer-by-layer by, repeatedly, providing a layer of material on a build platform and scanning a beam across the layer to consolidate the material, wherein a plurality of supports are provided for supporting the object during the build, each support comprising a main body attached to the object by a 2-dimensional pattern of frangible structures, the method further comprising applying an input force to the main body to displace the main body to break the frangible structures.

2. An method according to claim 1, comprising applying the input force to cause the main body to pivot to break the frangible structures, the input force applied at a location on the main body such that a lever action of the main body provides a resultant force on each of the frangible structures greater than the input force.

3. A method according to claim 2, wherein the input force is applied to a distal end of the main body that is remote from the frangible structures.

4. A method according to claim 1, comprising building the supports using the additive manufacturing process.

5. A method according to claim 4, comprising building the supports such that the solidified material that forms one or more of the main bodies is not fully dense.

6. A method according to claim 1, wherein the main body has a distal end portion to which the input force is applied that is a greater distance from a pivot point around which the main body pivots than the frangible structure that is furthest from the pivot point in a direction perpendicular to an axis of rotation about the pivot point.

7. A method according to claim 1, wherein at least one of the main bodies tapers from the object towards the build platform to provide a space between the main body and an adjacent main body of one of the other supports, the method comprising applying the input force to displace the or the adjacent main body into the space to break the frangible structures.

8. A method according to claim 1, wherein a top of each main body follows a contour of the object to provide a set gap between the main body and the object that is spanned by the frangible structures.

9. A method according to claim 8, wherein the height of the frangible structures is less than 1 mm.

10. A method according to claim 1, wherein a main body of one of the supports that is adjacent a main body of another support comprises an undercut into which a top of the main body of the other support projects.

11. A method according to claim 1, wherein one or more of the main bodies is hollow and/or comprise an aperture therein.

12. A method according to claim 1, wherein each support comprises further frangible structures that attach the main body to the build platform.

13. A support structure for supporting an object during additive manufacturing, wherein an object is built layer-by-layer by, repeatedly, providing a layer of material on a build platform and scanning a beam across the layer to consolidate the material, the support structure comprising a plurality of supports for supporting the object, each support comprising a main body attached to the object by a 2-dimensional pattern of frangible structures, the supports arranged such that the main bodies define a gap therebetween into which at least one of the main bodies can be displaced by an input force to break the frangible structures.

14. A support structure according to claim 13, wherein the supports are arranged such that the main body can be pivoted by the input force to break the frangible structures, a shape of the main body enabling the input force to be applied to a location on the main body to result in a resultant force on each of the frangible structures greater than the input force.

15. A support structure according to claim 13, wherein the main body has a distal end portion, to which the input force can be applied to pivot the main body about a pivot point, that is a greater distance from the pivot point than the frangible structure that is furthest from the pivot point in a direction perpendicular to an axis of rotation about the pivot point.

16. A support structure according to claim 13, wherein at least one of the main bodies tapers from the object towards the build platform to provide sufficient space between the main body and an adjacent main body of one of the other supports to enable pivotal movement of the or the adjacent main body into the space to break the frangible structures.

17. A support structure according to claim 13, wherein a top of each main body follows a contour of the object to provide a set gap between the main body and the object that is spanned by the frangible structures.

18. A support structure according to claim 17, wherein the height of the frangible structures is less than 1 mm.

19. A support structure according to claim 13, wherein a main body of one of the supports that is adjacent a main body of another support comprises an undercut into which a top of the main body of the other support projects.

20. A support structure according to claim 13, wherein one or more of the main bodies is hollow and/or comprise an aperture therein.

21. A support structure according to claim 13, wherein the solidified material that forms one or more of the main bodies is not fully dense.

22. A support structure according to claim 13, wherein each support comprises further frangible structures that attach the main body to the build platform.

23. Geometric data for use in controlling an additive manufacturing process, the geometric data defining an object to be built using the additive manufacturing process and support structures according to claim 13 for supporting the object during the additive manufacturing process.

24. A method of generating geometric data for use in controlling an additive manufacturing process, the method comprising, based on an object to be built using the additive manufacturing process, designing support structures according to claim 13 and generating geometric data defining the support structures.

25. A data carrier having instructions stored thereon, the instructions, when executed by a processor, causing the processor to receive object data defining an object to be built using an additive manufacturing process and to automatically generate geometric data defining support structures according to claim 13 on the object data.
